(19) United States
(12) Patent Application Publication
(10) Pub. No.: US 2008/0047219 A1
(43) Pub. Date: Feb. 28, 2008

(54) MOLDED CONSTRUCTION BLOCKS HAVING INTEGRALLY MOLDED KNOCK-OUTS FOR CREATION OF OPENINGS FOR ELECTRICAL BLOCKS AND ASSOCIATED METHODS

(75) Inventor: Dana Donohew, Atwater, OH (US)

Correspondence Address: CALFEE HALTER & GRISWOLD, LLP, 800 SUPERIOR AVENUE, SUITE 1400, CLEVELAND, OH, 44114, US

(73) Assignee: E.K.B. DESIGNS, LTD., Atwater, OH (US)

(21) Appl. No.: 11/780,273

(22) Filed: Jul. 19, 2007

Related U.S. Application Data
(60) Provisional application No. 60/807,724, filed on Jul. 19, 2006.
(60) Provisional application No. 60/826,648, filed on Sep. 22, 2006.

(51) Int. Cl. E04C 2/04; B28B 1/00

(52) U.S. Cl. 52/603; 425/441

(57) ABSTRACT

Masonry blocks are provided with at least one pre-formed or easily formed opening for an electrical box without requiring that an opening be cut with a saw or a chisel. One exemplary masonry block has at least one integrally molded opening for receiving an electrical box. Another exemplary masonry block has at least one integrally-molded knock-out that provides a selectably removable opening for receiving an electrical box. The knock-out may be formed of the same material from which the masonry block is molded, and may be, for example, formed with a thinned portion of a wall of the block or a plurality of cuts in a portion of a wall shaped the same as the electrical box opening.

### RELATED APPLICATIONS

This application claims priority to, and any other benefits of, U.S. Provisional Patent Application Ser. No. 60/807,724 filed Jul. 19, 2006, for MOLDED CONSTRUCTION BLOCKS HAVING INTEGRALLY MOLDED OPENINGS FOR ELECTRICAL BLOCKS AND ASSOCIATED METHODS (Attorney Docket No. 31545/04000), which is hereby incorporated by reference in its entirety. This application also claims priority to, and any other benefits of, U.S. Provisional Patent Application Ser. No. 60/826,648 filed Sep. 22, 2006, for MOLDED CONSTRUCTION BLOCKS HAVING INTEGRALLY MOLDED OPENINGS FOR ELECTRICAL BLOCKS AND ASSOCIATED METHODS (Attorney Docket No. 31545/04003), which is hereby incorporated by reference in its entirety.

### FIELD OF THE INVENTION

The present invention relates generally to masonry blocks for construction and more specifically to molded construction blocks having integrally molded openings therein, or integrally molded knock-outs for creation of openings therein, for electrical boxes and the like, and associated methods for manufacture and use thereof.

### BACKGROUND

It is common to constrict walls using masonry blocks made of cement, concrete or the like. Mortar is typically used between adjacent blocks to secure the blocks in place to construct walls and other building structures. It is also common to manually cut a hole in a block with a saw to provide an opening in a wall of the block to receive a standard electrical box, which electrical box may be used to mount electrical outlets, switches, and the like. The process of cutting a masonry block with a saw creates a significant amount of dust, which may create a hazard for masons if the dust includes crystalline silica dust. Sand and aggregate materials used in concrete may contain concentrated amounts of crystalline silica. When masons dry cut concrete products including masonry blocks they may be exposed to crystalline silica dust, and they may develop silicosis, a serious and incurable respiratory disease.

FIG. 1 shows a conventional electrical conduit box assembly 10 comprising a masonry block 12 having an opening 14 cut in one of the walls of the block, and having two interior cavities 16. The opening 14 is formed by manually cutting through the sides of the opening with a saw after the block 12 has been molded and cured. If a wet saw is used to cut opening 14, the block 12 will need to dry before it can be used. After the cuts are manually made with a saw, a tool, such as a hammer, is used to remove the cut piece to form the opening 14. A top edge of the opening 14 may be manually scored with a saw prior to removing the manually cut piece. An electrical box 18 has an associated conduit 20 for electrical wiring and is shown adjacent the opening 14. FIG. 2 shows the prior art masonry block 12 having an opening 14 formed as described above after the block 12 was molded and cured.

### SUMMARY

According to the present invention, masonry blocks are provided with at least one pre-formed opening for an electrical box, or easily formed opening for an electrical box (e.g., via an integrally molded knock-out), without requiring that an opening be cut with a saw. The masonry blocks of the present invention may be molded from cement, concrete, or the like.

According to one exemplary aspect of the present invention, a masonry block is provided having at least one wall having at least one integrally-molded knock-out that provides a selectably removable opening for receiving an electrical box. The knock-out may be formed of the same material from which the masonry block is molded, and may be, for example, formed with a thinned portion of a wall of the block or with a plurality of integrally molded cuts in a wall (or portion thereof). The integrally molded cuts forming the knock-out may be formed by flanges extending from a mold core into the mold cavity. The thinned portion or integrally molded cuts may be shaped the same as or substantially the same as the desired electrical box opening.

According to another exemplary aspect of the present invention, a masonry block is provided having at least one wall having at least one integrally molded opening for receiving an electrical box. The opening may be formed with a portion of a mold, e.g., a projection shaped like the opening that extends from a wall of the mold (or a projection that extends from the mold core), that displaces a portion of the material used to mold the masonry block. In the alternative, the opening may be formed with a separate insert (e.g., an insert of a different material) that is inserted in the mold before the masonry block is molded to form the opening for the electrical box. In this last example, the insert may be retained in the opening and carried by the masonry block prior to being knocked out to create the opening.

### BRIEF DESCRIPTION OF THE DRAWINGS

FIG. 1, is a perspective view of a prior art electrical conduit box mounted within a prior art masonry block having an opening for the box manually cut with a chisel or a saw;

FIG. 2, is a perspective view of a prior art masonry block having an opening manually cut with a chisel or a saw;

FIG. 3, is a perspective view of an exemplary masonry block according to the present invention;

FIGS. 4 and 5 are perspective views of an exemplary masonry block according to the present invention;

FIGS. 6, 7, and 10 are a perspective view of an exemplary masonry block having a knock-out according to the present invention;

FIGS. 8-9, and 11-12 are bottom plan views of exemplary masonry blocks having a knock-out according to the present invention;

FIG. 13 is a bottom perspective view of the exemplary masonry block of FIG. 12;

FIG. 14 is a bottom perspective view of the exemplary masonry block of FIGS. 12 and 13, with one integrally molded knock-out removed;

FIGS. 15-17 are perspective views of exemplary steps of a method of removing with a hammer an integrally molded knock-out from the exemplary masonry block of FIGS. 12-14;

FIG. 18 is a bottom perspective view of an exemplary mold shoe used in the manufacture of the exemplary masonry block of FIGS. 12-17;

FIG. 19 is a front elevational view of exemplary mold cores used in the manufacture of the exemplary masonry block of FIGS. 12-17;

FIG. 20 is a front/top/right perspective view of the exemplary mold cores of FIG. 19;

FIG. 21 is a rear elevational view of the exemplary mold cores of FIG. 9;

FIG. 22 is a rear/top/left perspective view of the exemplary mold cores of FIG. 19;

FIGS. 23-24 are top and rear views, respectively, of another pair of exemplary mold cores;

FIGS. 25-26 are bottom views of another exemplary mold shoe;

FIGS. 27-28 are top and rear views, respectively, of yet another exemplary pair of mold cores;

FIGS. 29A-29B shows various views of still another exemplary pair of mold cores; and

FIG. 30 is a bottom view of another exemplary mold shoe.

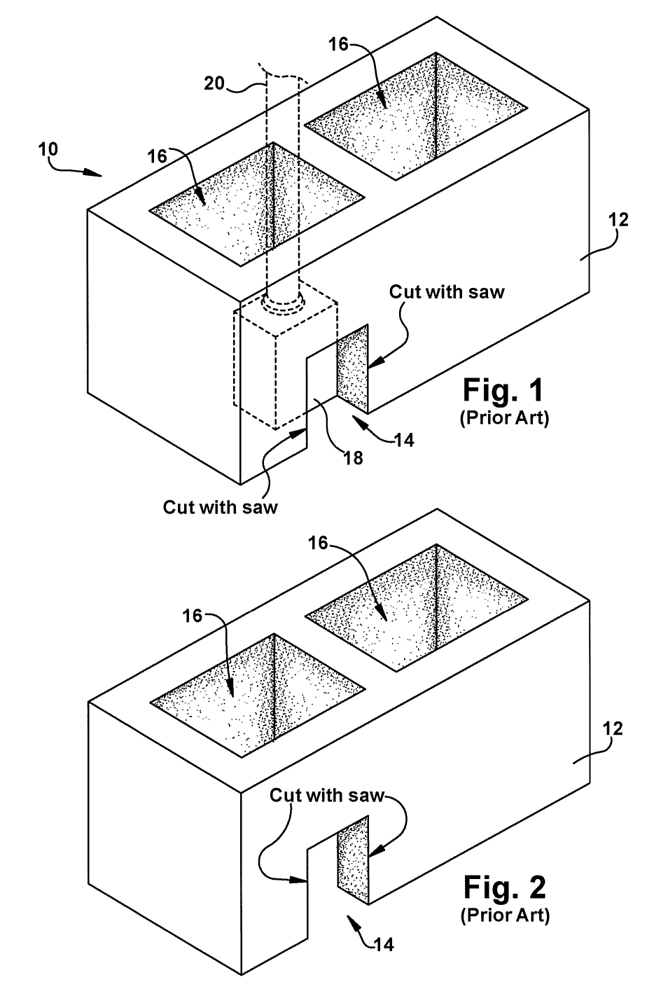

### DETAILED DESCRIPTION

Masonry blocks are provided with at least one pre-formed opening for an electrical box, or at least one easily formed opening for an electrical box, without requiring that an opening be cut with a saw.

According to one exemplary embodiment of the present invention, a masonry block is provided having at least one cavity sized to receive an electrical box for an electrical outlet or electrical switch, the electrical box having an electrical box opening for receiving an electrical outlet or electrical switch, and also having an integrally molded opening extending from outside the block to inside the block cavity, the integrally molded opening being sized to accommodate the electrical box and positioned so that an electrical box inserted into the cavity can be received by the integrally molded opening, and further wherein the opening is configured such that the electrical box opening of an electrical box inserted into the cavity may receive an electrical outlet or electrical switch. The opening may be formed with a portion of a mold, e.g., a projection shaped like the opening that extends from a wall of the mold (or a projection that extends from the mold core), that displaces a portion of the material used to mold the masonry block. In the alternative, the opening may be formed with a separate insert (e.g., an insert of a different material) that is inserted in the mold before the masonry block is molded to form the opening for the electrical box. In this last example, the insert may be retained in the opening and carried by the masonry block prior to being knocked out to create the opening.

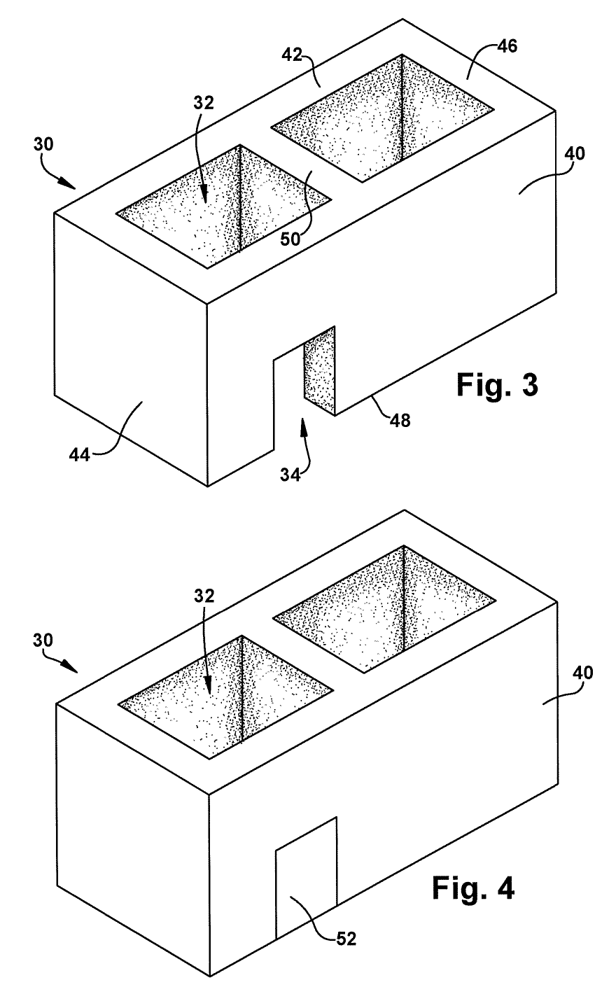

Referring now to FIG. 3, an exemplary masonry block 30 according to the present invention is shown. Exemplary masonry block 30 has at least one cavity 32 sized to receive an electrical box for an electrical outlet or electrical switch, the electrical box (not shown in FIG. 3) having an electrical box opening for receiving an electrical outlet or electrical switch, and also has an opening 34 extending from outside the block 30 to inside the block cavity 32, the opening 34 being sized to accommodate the electrical box and positioned so that an electrical box inserted into the cavity can be received by the integrally molded opening, and further wherein the opening is configured such that the electrical box opening of an electrical box inserted into the cavity may receive an electrical outlet or electrical switch. More specific to the example of FIG. 3, the exemplary masonry block 30 includes a first wall 40 and a second wall 42 that are arranged generally vertically and are spaced from each other. Exemplary masonry block 30 also includes a third wall 44 and a fourth wall 46 that are arranged generally vertically and are spaced from each other and that extend between the first and second walls 40, 42 to create the at least one cavity 32 (two such cavities are shown) sized to receive an electrical box for an electrical outlet or electrical switch, the electrical box having an electrical box opening for receiving an electrical outlet or electrical switch. In this exemplary embodiment, the first, second, third, and fourth walls 40-46 are integrally molded from cement, concrete or the like to form the masonry block 30 and at least one of the walls of the masonry block, here wall 40, has an integrally molded wall opening 34 that is sized to accommodate the electrical box for an electrical outlet or electrical switch and positioned so that an electrical box inserted into the cavity can be received by the integrally molded opening 34. Integrally molded wall opening 34 is shown positioned at a bottom edge of wall 40, but may instead be positioned at another edge or may be positioned at a point away from an edge, e.g., in about the midway point of the portion of wall 40 forming cavity 32 (not shown). Additionally, the wall opening 34 is configured such that the electrical box opening of an electrical box inserted into the cavity may receive an electrical outlet or electrical switch. Exemplary masonry block 30 is shown with an optional fifth wall 50 that is arranged generally vertically and is positioned between and spaced between the third and fourth walls 44, 46 and that extends between the first and second walls 40, 42 to create a plurality of cavities sized to receive an electrical box for an electrical outlet or electrical switch.

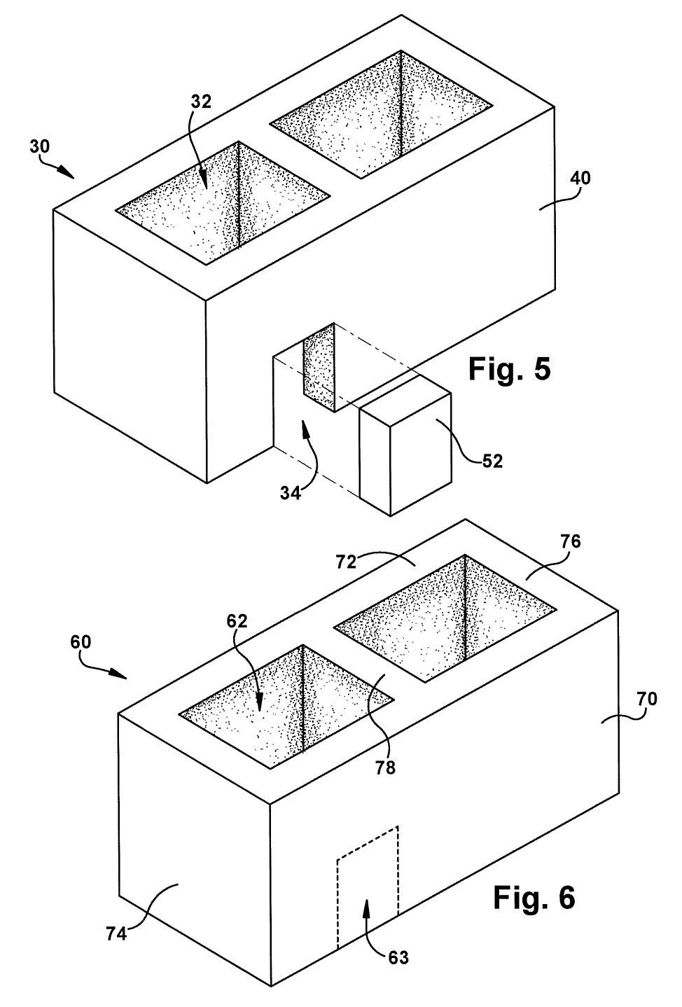

The exemplary block 30 may be formed with one or two or three or four openings 34 as described above. The openings 34 may be sized the same or differently to accommodate electrical boxes of different sizes, e.g., any one or more of the following sizes: about 2½″×3¾″ and/or about 4″×3¾″ and/or at least 2½″×3¾″ and/or at least 4″×3¾″ and/or other sizes. Additionally, if inserts 52—which may be parts of the core—are used, any one or more of the one or two or three or four inserts 52 used to form the corresponding openings 34 may be left in place for removal at the job site or removed prior to transport to the job site. FIG. 4 shows an exemplary block 30 carrying an exemplary insert 52 used to mold an opening 34. In FIG. 5, the insert is removed to expose the integrally molded opening 34, e.g., by striking the insert 52 with a hammer or other tool (not shown).

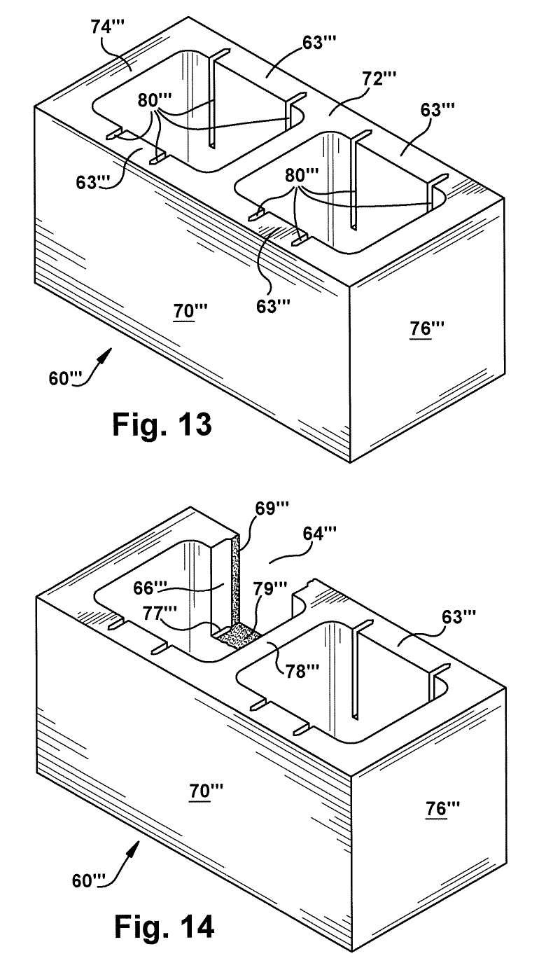

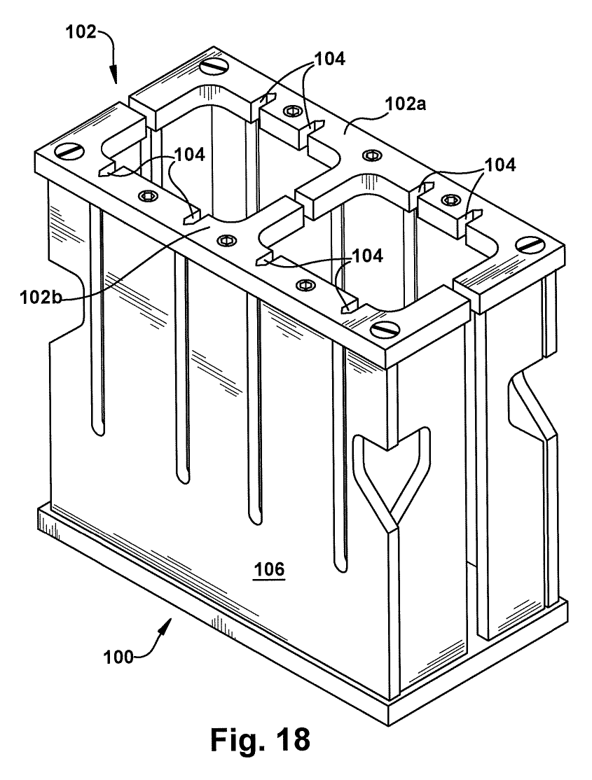

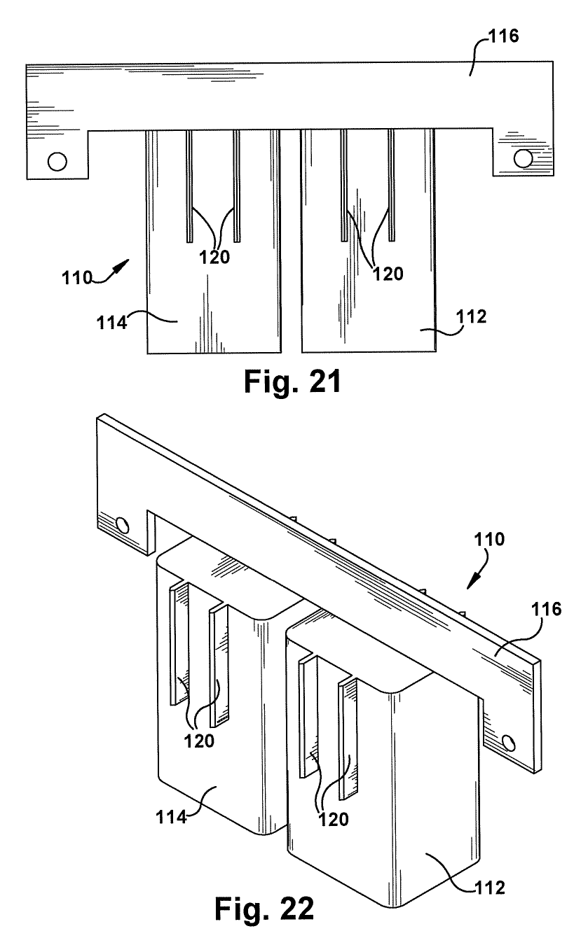

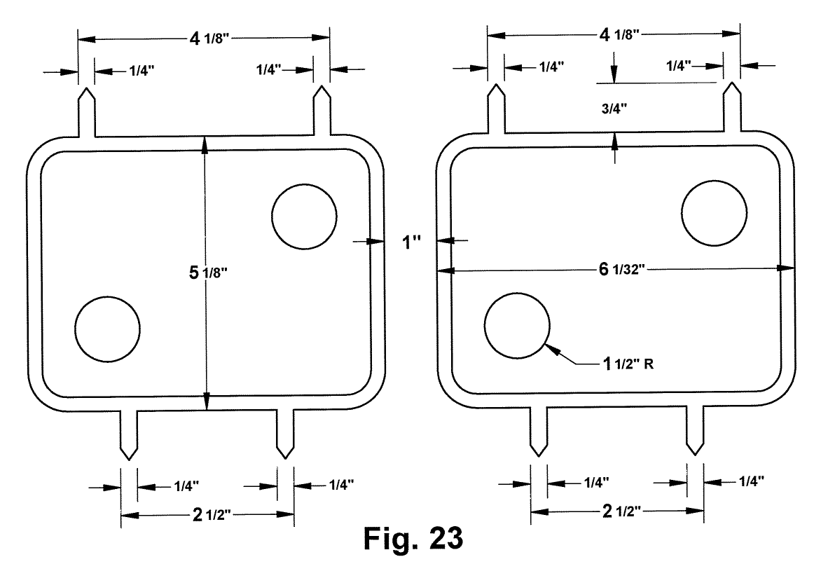

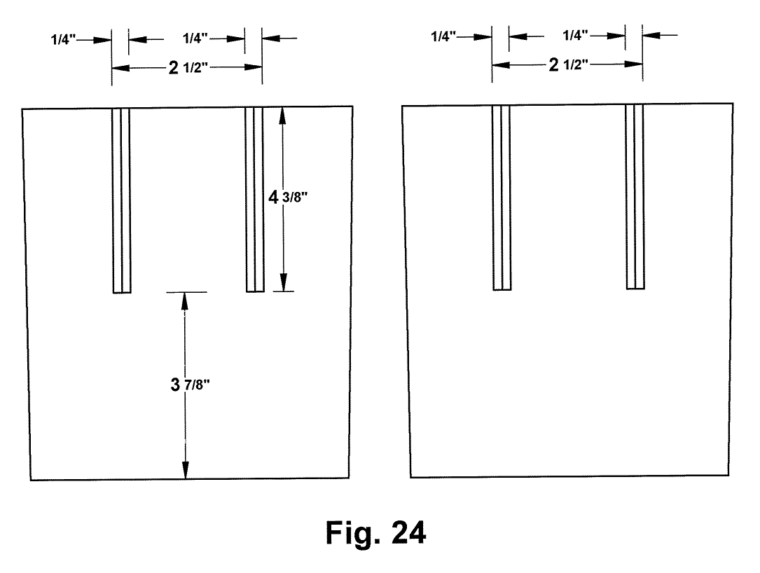

Using the teachings herein, the exemplary block 30 can be molded using traditional manual block molding techniques. Additionally, using the teachings herein, it is believed that one skilled in the art can mold the exemplary block 30 using BESSER brand automated block molding equipment, e.g., by molding the block upside-down as shown in FIGS. 13 and 14 and using the teachings about mold cores and mold shoes discussed herein (e.g., FIGS. 18-28).

According to another exemplary embodiment of the present invention, a masonry block is provided having at least one cavity sized to receive an electrical box for an electrical outlet or electrical switch, the electrical box having an electrical box opening for receiving an electrical outlet or electrical switch, and also having an integrally molded knock-out that when removed forms an opening extending from outside the block to inside the block cavity, the integrally molded opening being sized to accommodate the electrical box and positioned so that an electrical box inserted into the cavity can be received by the integrally molded opening, and further wherein the opening is configured such that the electrical box opening of an electrical box inserted into the cavity may receive an electrical outlet or electrical switch. The knockout may be formed of the same material from which the masonry block is molded, and may be, for example, formed with a thinned portion of a wall of the block or formed from a plurality of integrally molded cuts molded in a wall (or a portion thereof) and shaped the same as the electrical box opening.

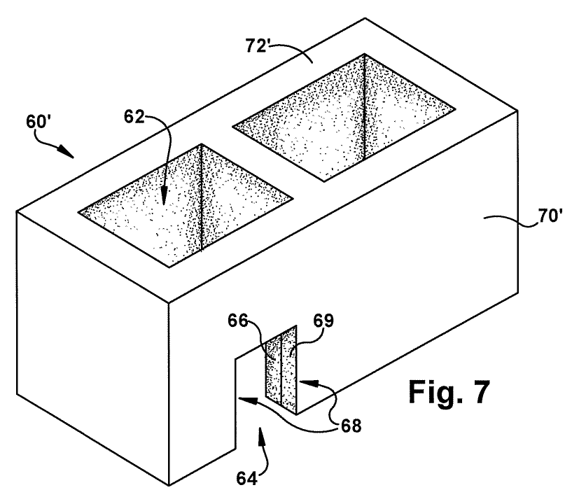

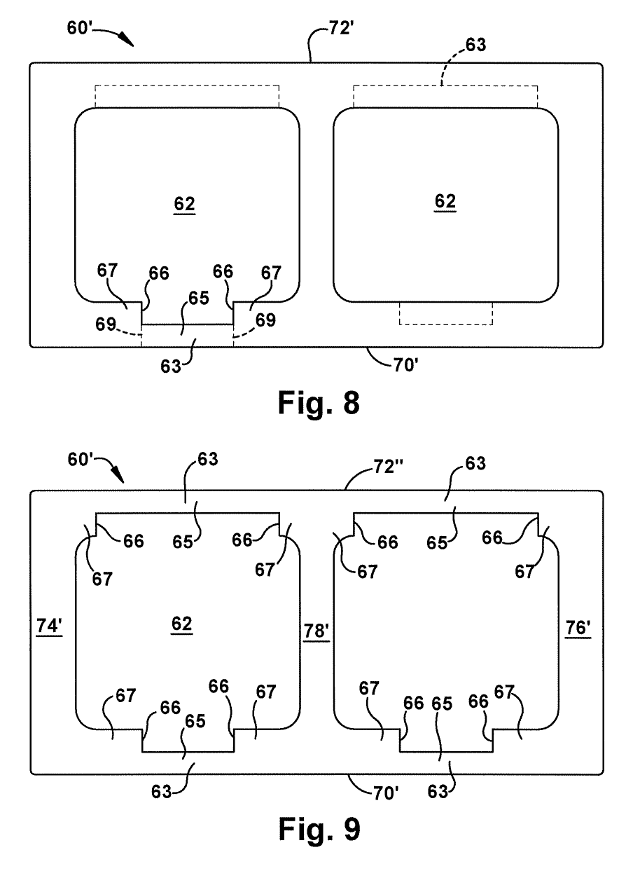

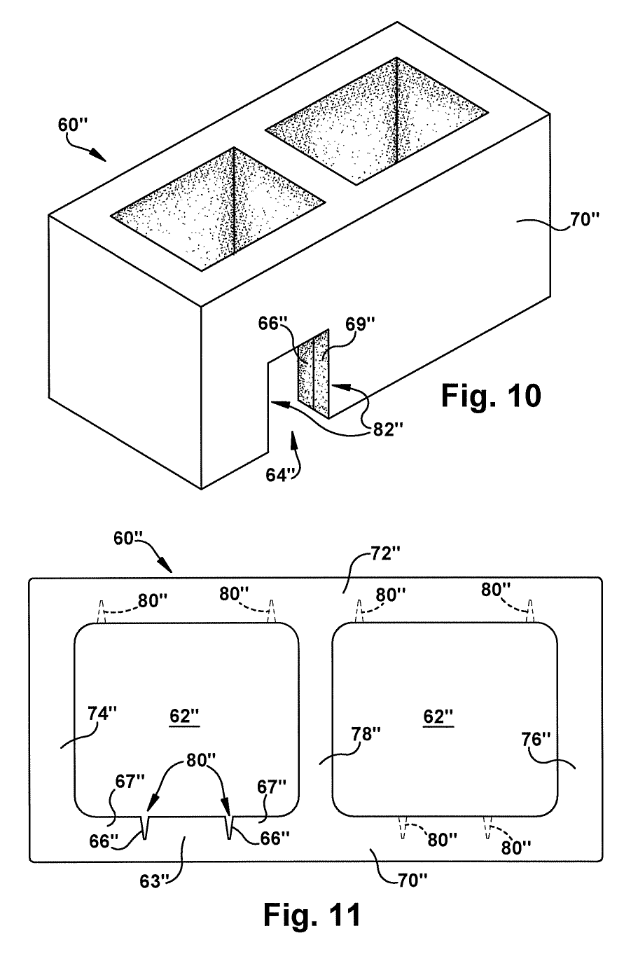

Referring now to FIGS. 6-17, another exemplary masonry block 60 according to the present invention is shown. One exemplary implementation 60′ of block 60 is shown in FIG. 7 and another exemplary implementation 60″ of block 60 is shown in FIG. 10. Examples of each are shown in FIGS. 8-9 and 11-17.

Exemplary masonry block 60 has at least one cavity 62 sized to receive an electrical box for an electrical outlet or electrical switch, the electrical box (not shown in FIG. 6) having an electrical box opening for receiving an electrical outlet or electrical switch, and also has at least one integrally-molded knock-out 63 that when removed forms an opening 64 (e.g., FIGS. 7 and 10) extending from outside the block 60 to inside the block cavity 62, the knock-out 63 and the corresponding opening 64 being sized to accommodate the electrical box and positioned so that an electrical box inserted into the cavity can be received by the opening formed by removing the knock-out 63, and further wherein the opening is configured such that the electrical box opening of an electrical box inserted into the cavity may receive an electrical outlet or electrical switch. More specific to the examples of FIGS. 6-17, the exemplary masonry block 60 includes a first wall 70 and a second wall 72 that are arranged generally vertically and are spaced from each other. Exemplary masonry block 60 also includes a third wall 74 and a fourth wall 76 that are arranged generally vertically and are spaced from each other and that extend between the first and second walls 70, 72 to create the at least one cavity 62 sized to receive an electrical box for an electrical outlet or electrical switch, the electrical box having an electrical box opening for receiving an electrical outlet or electrical switch. In this exemplary embodiment, the first, second, third, and fourth walls 70-76 are integrally molded from cement, concrete or the like to form the masonry block 60, and at least one of the walls of the masonry block, here wall 70, has at least one integrally molded knock-out 63 that when removed forms wall opening 64 that is sized to accommodate the electrical box for an electrical outlet or electrical switch and positioned so that an electrical box inserted into the cavity can be received by the integrally molded opening 64. Integrally molded knock-out 63 and corresponding wall opening 64 are shown positioned at a bottom edge of wall 70, but may instead be positioned at another edge or may be positioned at a point away from an edge, e.g., in about the midway point of the portion of wall 70 forming cavity 62 (not shown). Additionally, the knock-out 63 and corresponding wall opening 64 are configured such that the electrical box opening of an electrical box inserted into the cavity may receive an electrical outlet or electrical switch. Exemplary masonry block 60 is shown with an optional, inner fifth wall 78 that is arranged generally vertically and is positioned between and spaced between (and generally parallel to) the third and fourth walls 74, 76 and that extends between the first and second walls 70, 72 to create a plurality of cavities sized to receive an electrical box for an electrical outlet or electrical switch.

The integrally molded knock-out 63 may be formed of the same material from which the masonry block is molded, and may be, for example, formed with a thinned portion of a wall of the block (FIGS. 7-9) or a plurality of cuts integrally molded in a wall (or portion thereof) (FIGS. 10-17), and may be shaped the same as the electrical box or its opening. The knock-out 63 may be physically removed to form the electrical box opening 64, e.g., with sharp blows from a hammer or the like. The side walls 74, 76 are shown in the figures as being solid walls without any cuts, openings, or knock-outs. Cuts, openings, and/or knock-outs in the side walls (or inner walls 78, if any) may weaken the block to the extent that the block may be severely damaged (e.g., a corner broken off, or a wall or portion of a wall broken off) when the knock-out is struck during removal. Thus, although the side walls may optionally have openings or knock-outs, if the knock-outs are to be removed by striking, it is preferable that the side walls 74,76 (in cooperation with inner walls 78, if any) are configured to make the block 60 strong enough to permit the knock-out 63 to be removed by blows from a tool, such as a hammer or the like. Additionally, knock-outs 63 may be left in place for removal at the job site or removed prior to transport to the job site.

FIGS. 7-9 show exemplary blocks 60′ having an integrally molded knock-out 63 formed from a thin portion 65 of a block wall that steps up at a step 66 to a thicker wall portion 67. After the knock-out 63 of exemplary block 60′ has been removed, e.g., with a sharp blow from a hammer or the like, a wall opening 64′ is created having at least pair of walls 68 formed in part by the stepped portion 66 and formed in part by a broken region 69 where the thin portion 65 was broken away. FIG. 8 is shown with a single knock-out 63, although two or three or four or more may be used. FIG. 9 is shown with four knock-outs 63, with two smaller knockouts on one wall 70′ and two larger knock-outs on another wall 72′.

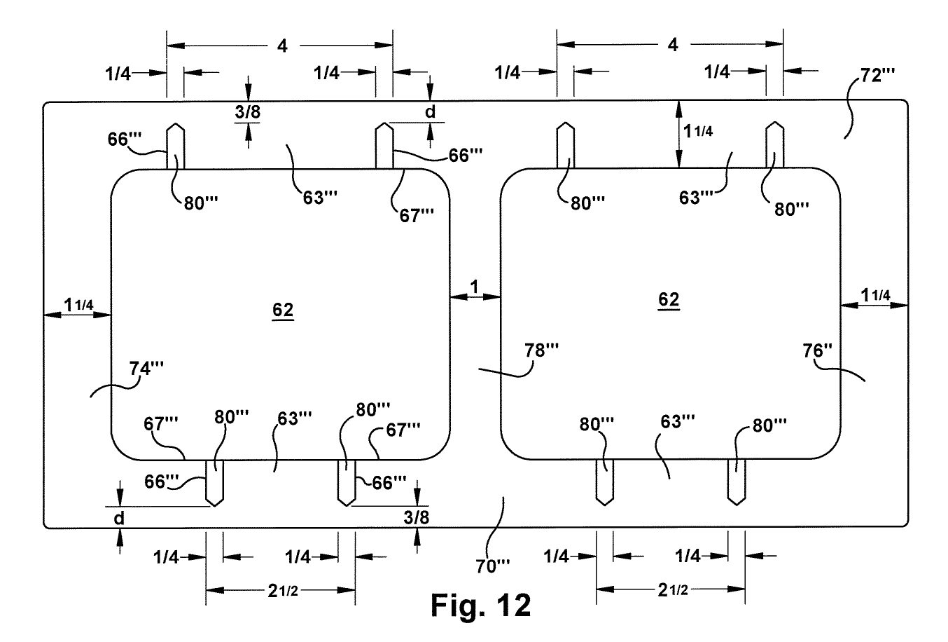

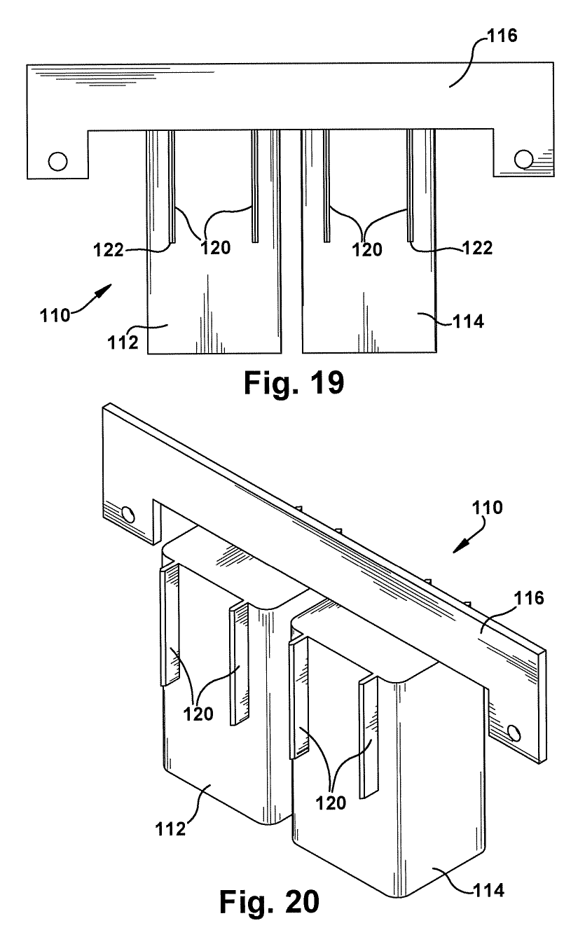

Referring now to FIGS. 10-17, exemplary blocks are shown having at least one integrally molded knock-out formed from cuts integrally molded in the wall(s) of the block. The cuts may be formed from projections extending from a mold core or a mold wall into the mold cavity. FIGS. 10-11 show exemplary blocks 60″ having an integrally molded knock-out 63″ formed from cuts 80″ in a block wall. Cuts 80″ form a sort of step down 66″ from a thicker wall portion 67″. After the knock-out 63″ of exemplary block 60″ has been removed, e.g., with a sharp blow from a hammer or the like, a wall opening 64″ is created having at least a pair of walls 82″ formed in part by the stepped portion 66″ formed by the cut 80″ and formed in part by a broken region 69″ where the knock-out 63″ was broken away. The upper portion of opening 64″ may be formed entirely from broken wall (i.e., there need be no cut forming the upper portion of opening 64″). FIG. 11 is shown with a single knock-out 63″, although two or three or four or more may be used (e.g., FIGS. 12-26). Exemplary block 60″ may be formed with two smaller knockouts on one wall 70″ and two larger knock-outs on another wall 72″. The cuts 80″ may be formed on the inside or the outside of the blocks. The cuts 80″ may be sized to fit an electrical box or slightly larger (e.g., about 3.75 inches high, or at least 3.75 inches high, or about 4 inches high, or at least 4 inches high, or about 4⅜ inches high, or at least 4⅜ inches high). The cuts may be formed using projections extending from a mold core (e.g., FIGS. 19-22) or projections extending from a mold wall (not shown).

The exemplary blocks 60, 60′, and 60″ may be formed with one or two or three or four openings 34 as described above. The openings 34 may be sized the same or differently to accommodate electrical boxes of different sizes, e.g., any one or more of the following sizes: about 2½″×3¾″ and/or about 4″×3¾″ and/or about 2⅝″×3¾″ and/or about 4⅛″×3¾″ and/or about 4⅜″×4⅜″ and/or about 2⅝″×4″ and/or at least 2½″×3¾″ and/or at least 4″×3¾″ and/or at least 2⅝″×3¾″ and/or at least 4⅛″×3¾″ and/or at least 4⅜″×4⅜″ and/or at least 2⅝″×4″ and/or other sizes.

FIGS. 12-17 show an exemplary masonry block 60′″ having a plurality of knock-outs 63′″ formed from cuts 80′″ integrally molded in the walls of the block and formed by flanges extending from the mold core. More specifically, the exemplary block 60′″ of FIGS. 12-17 is shown with four knock-outs 63′″, with two smaller (2½″) knockouts on one wall 70′″ and two larger (4″) knock-outs on another wall 72′″.

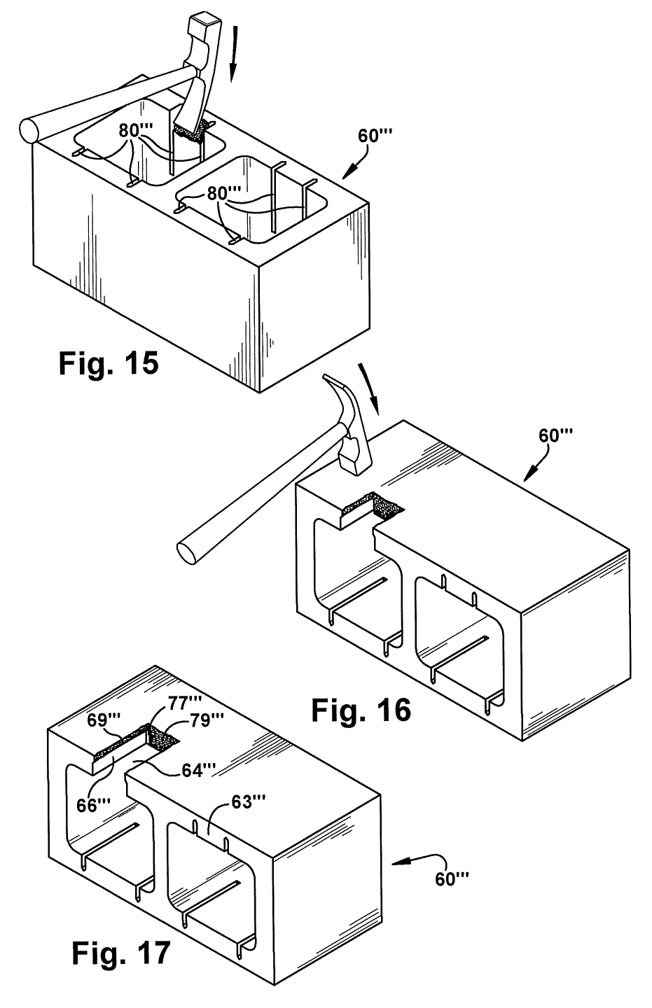

The cuts 80′″ of block 60′″ are shaped differently than the cuts 80″ of block 60″, with the cuts 80′″ having a long rectangular portion and a distal tapered portion. As with the blocks 60″ discussed above, the pre-molded cuts 80′″ of block 60′″ form a sort of step down from a thicker wall portion 67′″ at a stepped portion 66′″. After one or more knock-outs 63′″ of exemplary block 60′″ have been removed, e.g., with a sharp blow from a hammer or the like (e.g., FIGS. 15-17), a wall opening 64′″ is created having at least a pair of walls formed in part by the stepped portion 66′″ formed by the cut 80′″ and formed in part by a broken region 69′″ where the knock-out 63′″ was broken away. The upper region of the opening 64′″ is formed for the most part by broken wall portion 79′″ and perhaps also a molded portion 77′″ corresponding to the bottom of the flanges used to mold the cuts. The cuts 80′″ in this example are formed on the inside of the blocks 60′″. In this example, the cuts 80′″ do not run the entire height of the block, rather, they are about 3¾ inches high, which creates knock-outs 60′″ that have a height sized to fit exemplary electrical boxes. Accordingly, the flanges extending from the mold core may be taller than 3¾ inches high for use with automated block manufacturing equipment. The flanges F in this example are rectangular and extend about ⅞″ from the outside of the mold core. The edges of the flanges F may be beveled, as shown. Thus, the block wall thickness at the cuts (“d” in FIG. 12) formed by the flanges in the exemplary block 60′″ is shown as being about ⅜″; however, different block wall thicknesses at the cuts 60′″ (e.g., between ¼″ and ½″ or more) may be acceptable as well (a wall thickness d of about ½″ at all eight of the cuts 60′″ would provide for a stronger block and may still provide for acceptable knock-outs). Additionally, the 4″ spacing for the wider knock-outs may be widened to about 4⅛″ to provide adequate clearance for a corresponding electrical box after the knock-outs are removed. The 2½″ inch spacing for the narrower knock-outs may also be widened a little, if desired.

FIGS. 15-17 show one of the knock-outs 63′″ of a block 60′″ being removed with a tool. The knock-out 63′″ is repeatedly struck starting at the exposed bottom edge of the knock-out 63′″ and moving inward toward the center of the wall until the entire knock-out 63′″ has been removed. The block 60′″ may be generally horizontal during this entire process. In the alternative, as shown in FIGS. 15-17, the orientation of the block 60′″ may be changed to facilitate removal of the knock-out 63′″. As shown in FIG. 15, with the exposed bottom edge of the knock-out 63′″ facing upwards, a tool may be used to remove chunks of the knock-out 63′″ working downward. After the removal process has been started, the block may be turned on its side, as shown in FIGS. 16-17, as subsequent blows remove piece after piece of the knock-out 63′″ until the opening 64′″ is formed as desired. The knock-outs of the present invention may be very quickly removed using a hammer or other tool without pre-cutting (e.g., with respect to the block of FIGS. 13-14, a skilled mason can remove the smaller knock-outs with a hammer in about 30 seconds and can remove the larger knock-outs with a hammer in about 45 seconds, without the use of a saw).

Using the teachings herein, the exemplary blocks 60, 60′, 60″, and 60′″ can be molded using traditional manual block molding techniques. Thus, using the teachings herein, it is believed that one skilled in the art can mold these exemplary blocks using BESSER brand automated block molding equipment, e.g., by molding the block upside-down as shown in FIGS. 13 and 14.

FIGS. 18-22 show exemplary implementations of mold cores and a mold shoe, which may be used to fabricate exemplary blocks 60′″ using automated block molding equipment. FIG. 18 shows as exemplary implementation of a shoe assembly 100 having a split shoe 102 comprising two pieces 102a, 102b (split to accommodate the core bar, as known to those skilled in the art). FIG. 19-22 show an exemplary implementation of a mold core assembly 110 having a pair of mold cores 112, 114, connected by a core bar 116 to facilitate automatic molding with automated block molding equipment. The mold core assembly 110 and shoe assembly 100 may be used with various mold cavities having various mold wall configurations to create various external block wall features. Of course one or more such mold core assembly 110 and shoe assembly 100 may be used, depending on which block molding equipment is being used, and different core bar 116 configuration and shoe support 106 configuration may be required for different automated equipment.

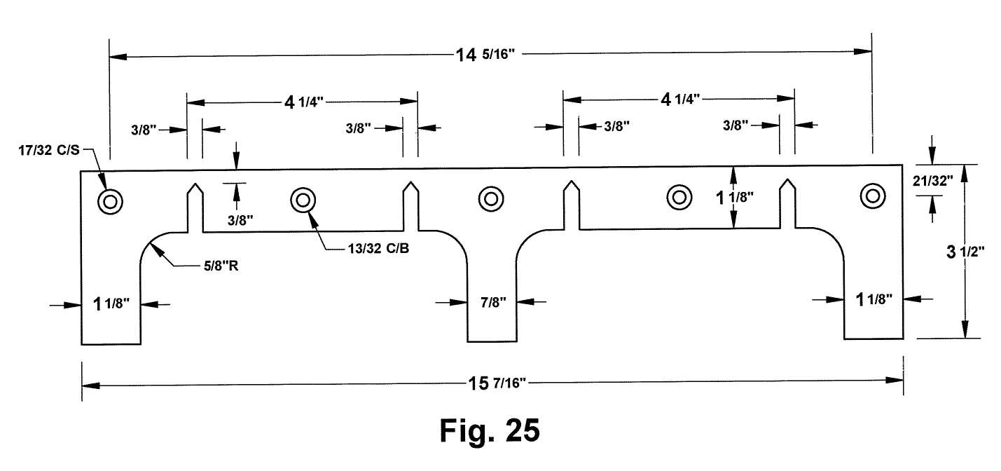

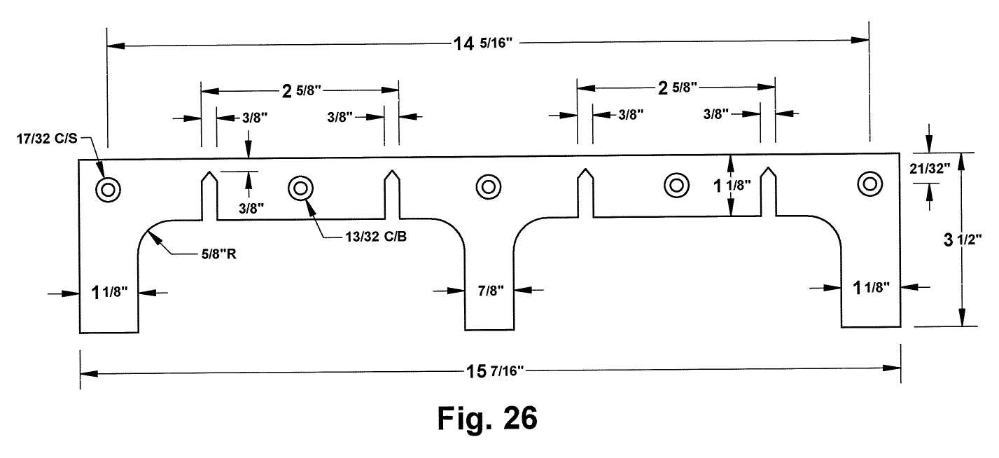

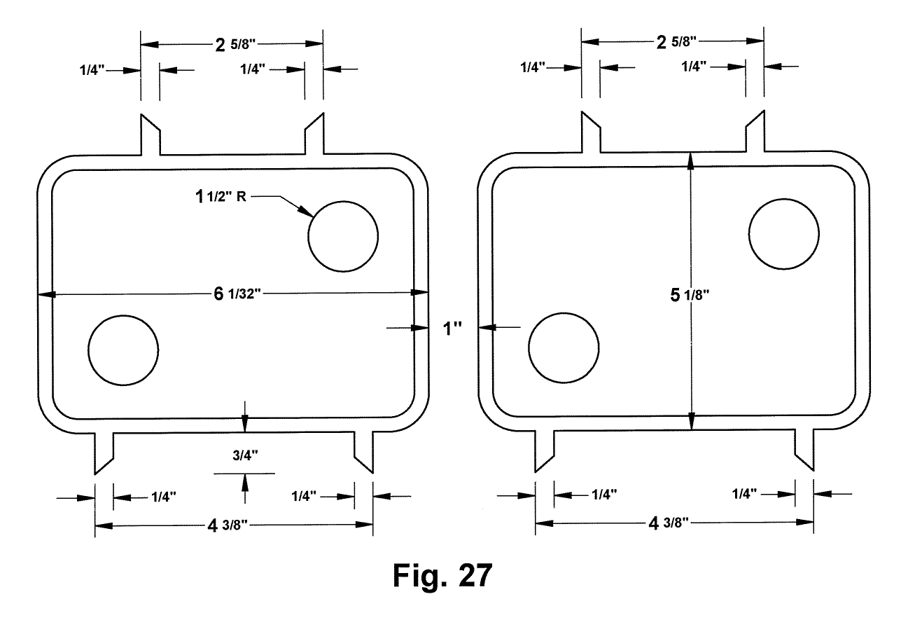

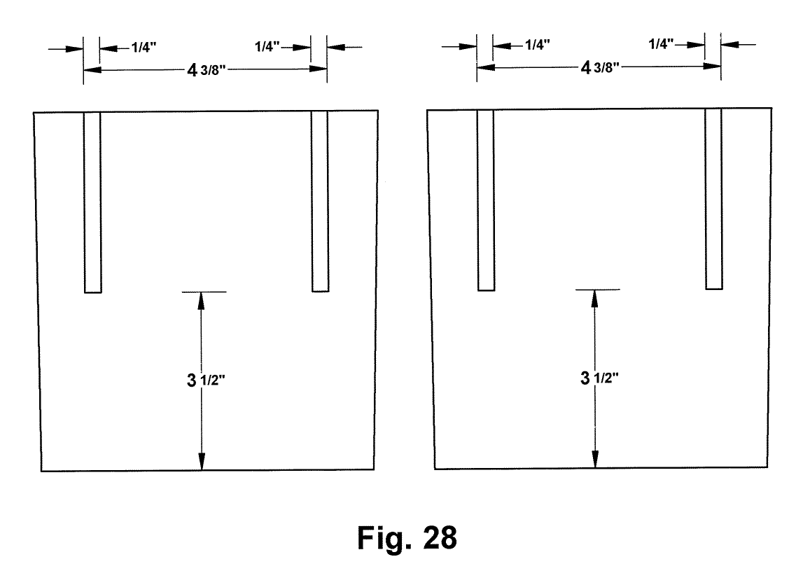

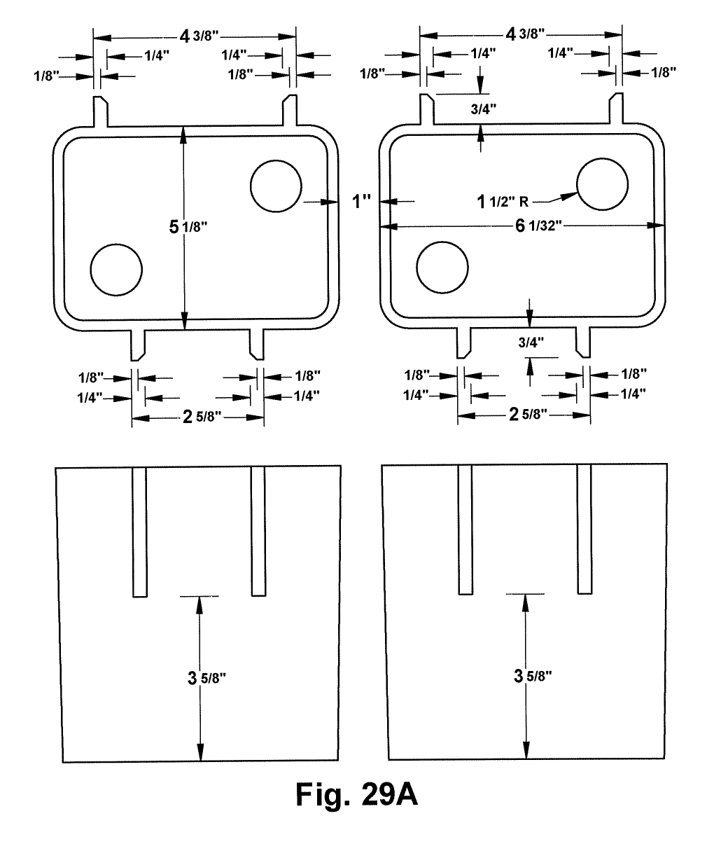

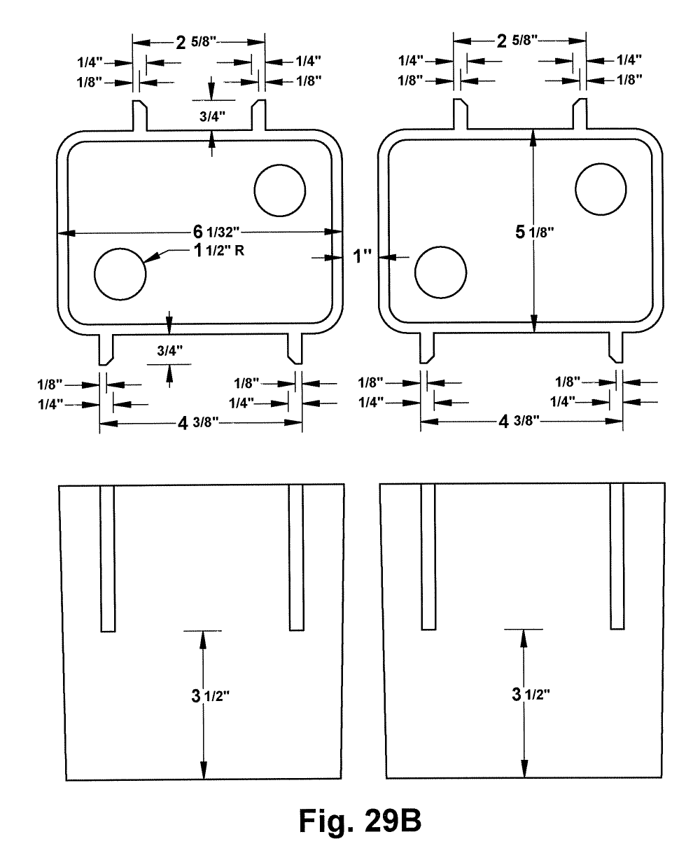

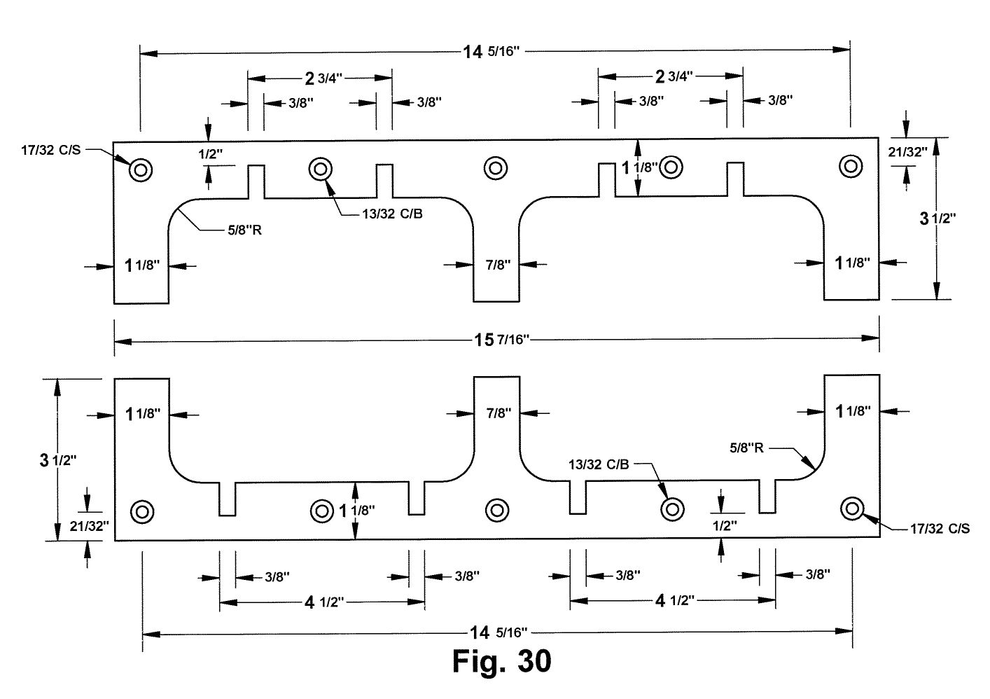

The exemplary mold cores 112, 114 shown each have four flanges 120 that form pre-molded cuts 80′″ in blocks 60′″ in four locations, as discussed above. As known to those skilled in the art, the exemplary cores may have spring-loaded members (not shown) that extend from their undersides to facilitate use with automated block molding equipment. The shoe pieces 102a, 102b have notches 104 corresponding in location with, and sized slightly wider than, the flanges 120. The mold cores 112, 114 and flanges 120 may be configured as in FIG. 12 or FIGS. 23-24 or FIGS. 27-28 or FIGS. 29A-29B, or in some other configuration; the shoe pieces 102a, 102b may be configured as shown in FIGS. 25-26 or in FIG. 30, or in some other configuration (e.g., corresponding to FIG. 12 or FIGS. 27-28). Using the mold core of FIGS. 27-28 will result in knock-outs with nominal widths of 4¼″ inches for 4-inch boxes and 2⅝″ inches for 2½-inch boxes, which permits a less skilled worker to knock out the knock-out using a hammer or other tool and easily have enough clearance to insert the electrical box into its opening (the narrower the nominal size of the opening, the more careful one must be in removing the knock-out to ensure that the opening will accommodate the box). The longitudinal edge of the flanges 120 may be tapered, as shown in FIGS. 11, 12, and 23-24. Additionally, the longitudinal edge may extend at its deepest location into the block at the outermost edge of the opening, as shown in FIGS. 27-28, which may also facilitate easily removing the knock-out to provide a sufficiently wide opening. The shorter edges 122 of the flanges 120 may be flat (which would form a corresponding flat in the cuts 80, as shown at 77 in FIG. 14) or some other shape, e.g., tapered.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. For example, the thin portion(s) 65 forming knock-outs 63 may be formed from mold inserts carried by the molded block, as discussed in the context of FIGS. 3-5. As another example, the configuration of the mold and/or the shoe could be changed, and still provide integrally molded knock-outs for creation of openings therein for electrical boxes and the like. As yet another example, the blocks disclosed herein may be used to accept the ends of rebar in connection with a poured concrete floor (a series of the blocks disclosed herein will be lined up to form an edge of such a floor, with the ends of rebar perhaps bent in an L, and inserted from the top into the cavity of the blocks, and with the rebar accepted into the electrical box openings, which face upwards; the floor would be poured at about the same height as the upper surface of the blocks). Therefore, the invention in its broader aspects is not limited to the specific details, representative apparatus and methods, and illustrative examples shown and described. Accordingly, departures may be made from such details without departing from the spirit or scope of the applicant's general inventive concept.

What is claimed is:

1. A masonry block, comprising:
first and second walls that are arranged generally vertically and are spaced from each other; and
third and fourth walls that are arranged generally vertically and are spaced from each other and that extend between the first and second walls to create the at least one cavity sized to receive an electrical box for an electrical outlet or electrical switch, the electrical box having an electrical box opening for receiving an electrical outlet or electrical switch; and
wherein the first, second, third, and fourth walls are integrally molded from cement, concrete or the like to form the masonry block; and
wherein at least one of the walls of the masonry block has an integrally molded wall opening that is sized to accommodate the electrical box for an electrical outlet or electrical switch and positioned so that an electrical box inserted into the cavity can be received by the integrally molded opening, and further wherein the wall opening is configured such that the electrical box opening of an electrical box inserted into the cavity receives an electrical outlet or electrical switch.

2. The masonry block of claim 1 wherein the masonry block carries in the integrally molded opening an insert that was used to form the opening during the molding of the masonry block, which insert is knocked out before the masonry block accepts the electrical box.

3. A masonry block, comprising:
first and second walls that are arranged generally vertically and are spaced from each other; and
third and fourth walls that are arranged generally vertically and are spaced from each other and that extend between the first and second walls to create the at least one cavity sized to receive an electrical box for an electrical outlet or electrical switch, the electrical box having an electrical box opening for receiving an electrical outlet or electrical switch; and
wherein the first, second, third, and fourth walls are integrally molded from cement, concrete or the like to form the masonry block; and
wherein at least one of the walls of the masonry block has an integrally molded knock-out that, when removed, provides a wall opening that is sized to accommodate the electrical box for an electrical outlet or electrical switch and positioned so that an electrical box inserted into the cavity can be received by the wall opening formed by removing the integrally molded knock-out, and further wherein the wall opening is configured such that the electrical box opening of an electrical box inserted into the cavity receives an electrical outlet or electrical switch.

4. The masonry block of claim 3 further comprising a fifth wall that is arranged generally vertically and is positioned between and spaced between the third and fourth walls and that extends between the first and second walls to create a plurality of cavities sized to receive an electrical box for an electrical outlet or electrical switch.

5. The masonry block of claim 3 wherein the knock-out is formed at least in part from a thin wall portion that steps from a thicker wall portion.

6. The masonry block of claim 3 wherein the knock-out is formed at least in part from at least two cuts formed during molding of the block.

7. The masonry block of claim 6 wherein the knock-out is formed at least in part from at least two cuts formed on an inside surface of one of the walls during molding of the block.

8. The masonry block of claim 3 wherein at least one of the walls of the masonry block has a plurality of integrally molded knock-outs that, when removed, provide a wall opening that is sized to accommodate the electrical box for an electrical outlet or electrical switch and positioned so that an electrical box inserted into the cavity can be received by the wall opening formed by removing the integrally molded knock-out, and further wherein the wall opening is configured such that the electrical box opening of an electrical box inserted into the cavity receives an electrical outlet or electrical switch.

9. The masonry block of claim 8 wherein the knockouts are each formed at least in part from at least two cuts formed during molding of the block.

10. The masonry block of claim 8 wherein the plurality of knock-outs comprise a wider knock-out formed at least in part from at least two cuts formed on one wall during molding of the block and a narrower knock-out formed at least in part from at least two cuts formed on a different wall during molding of the block.

11. The masonry block of claim 3 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.

12. The masonry block of claim 11 wherein walls of the masonry block adjacent the at least one wall having an integrally molded knock-out are free of integrally molded cuts and openings.

13. The masonry block of claim 4 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.

14. The masonry block of claim 7 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.

15. The masonry block of claim 8 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.

16. The masonry block of claim 9 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.

17. A method of manufacturing a masonry block, comprising:
(a) providing a mold core that cooperates with mold walls to form a mold cavity for a masonry block comprising:
first and second walls that are arranged generally vertically and are spaced from each other; and
third and fourth walls that are arranged generally vertically and are spaced from each other and that extend between the first and second walls to create the at least one cavity sized to receive an electrical box for an electrical outlet or electrical switch, the electrical box having an electrical box opening for receiving an electrical outlet or electrical switch; and
wherein at least one of the walls of the masonry block has an integrally molded knock-out that, when removed, provides a wall opening that is sized to accommodate the electrical box for an electrical outlet or electrical switch and positioned so that an electrical box inserted into the cavity can be received by the wall opening formed by removing the integrally molded knock-out, and further wherein the wall opening is configured such that the electrical box opening of an electrical box inserted into the cavity receives an electrical outlet or electrical switch; and
(b) dispensing cement, concrete or the like into the mold cavity to form the masonry block such that the first, second, third, and fourth walls are integrally molded together.

18. The method of manufacturing a masonry block of claim 16 wherein the mold core comprises a plurality of generally parallel flanges extending from an outside surface of the mold core into the mold cavity to form cuts in an inside wall of the block to form the knock-out(s).

19. The method of manufacturing a masonry block of claim 16 wherein the mold core comprises a plurality of pairs of generally parallel flanges extending from an outside surface of the mold core into the mold cavity to form cuts in an inside wall of the block to form the knock-out(s).

20. The method of manufacturing a masonry block of claim 18 wherein walls of the masonry block adjacent the at least one wall having an integrally molded knock-out are configured to provide sufficient strength to permit the integrally molded knock-out to be removed by striking with a tool without the at least one wall having an integrally molded knock-out collapsing.
